(19) United States
(12) Patent Application Publication
(10) Pub. No.: US 2007/0092104 A1
(43) Pub. Date: Apr. 26, 2007

(54) Content authentication system and method

(76) Inventor: Shinhaeng Lee, San Diego, CA (US)

Correspondence Address: SHINHAENG LEE, 3519 CAMINITO EL RINCON, #300, SAN DIEGO, CA, 92130, US

(21) Appl. No.: 11/259,000

(22) Filed: Oct. 26, 2005

(51) Int. Cl. G06K 9/00

(52) U.S. Cl. 382/100; 348/222.1

(57) ABSTRACT

A content capture device with watermarking features provides the ability to encode a captured content item with identification information to identify an owner or other interested party. The content capture device can be implemented as a digital camera or other device suitable for capturing digital content, whether it be audio, visual or other content. The identification information. can be obtained using various techniques such as user entry, downloading or through the use of a biometric sensor.

### FIELD OF THE INVENTION

The present invention relates generally to electronic content devices, and more particularly to a system and method for authenticating digital content.

### BACKGROUND OF THE INVENTION

Digital cameras, video recorders and other digital content capture devices enjoy widespread popularity with both professionals and consumers. With advances in technology, such portable electronic devices have become a ubiquitous part of our contemporary society. However, with digital content, copyright and ownership control has become difficult to manage.

Much to the chagrin of publishers, producers and artists, their digital content can be copied, and recopied almost without limit while still preserving the integrity and quality of the original content. Also electronic files can be easily copied, downloaded and otherwise shared among multiple users, almost instantaneously and across unlimited geographic boundaries making electronic piracy an acute problem.

Hardcopy publications, have at times been provided with a watermark to identify. the owner or to evidence originality of the publication. One example is in the marking, of paper currency to establish authenticity, wherein a watermark can be seen when the bill is held to a light source. Because it is a complex and expensive process it is difficult for counterfeiters to duplicate. Another example of watermarking is where the copyright holder of a digital image overlays their copyright designation on digital photos posted on their website. In this example, the copyright designation is typically done at some level of transparency so as to not overly detract from the image, while still identifying the image and any copies thereof as belonging to the designated copyright holder. Other forms of watermarking are used by companies, government agencies, check printers and the like to maintain information in a document secret or to flag unauthorized copies.

### BRIEF SUMMARY OF THE INVENTION

According to one embodiment of the invention, a digital camera, digital video recorder or other content capture device is provided with the functionality to encode identification information with the captured content to allow authentication and tracking of the encoded content item. More particularly, in accordance with one embodiment of the invention, the identification of the author or owner of an item of digital content is encoded onto the content item, such that examination of the content item with appropriate decoding techniques reveals the identity of the author of that item. As a specific example, in one application a digital image is encoded with the identification of the photographer of a digital photograph such that the photographer can be identified in the original and in copies of the photograph.

In one embodiment, a digital camera, comprises optical elements configured to focus an image onto a focal plane; an image capture medium positioned at the focal plane configured to capture the image focused onto the focal plane; image control logic configured to process an image captured by the image capture medium; a biometric sensor configured to detect a biometric parameter of a user of the camera; feature extraction control logic configured to extract one or more features of the captured biometric parameter; matching control logic configured to determine the identification of the user of the camera based on the extracted one or more features; and marking control logic configured to encode a digital representation of the captured image with an identification of the user. In one embodiment, the marking control logic is further configured to compress the captured image. The digital camera can include a digital still camera a digital video camera or other digital image capture device including those found with cellular telephones and other electronic devices. The digital camera is further can be further configured to capture audio content and said marking control logic is further configured to encode the captured audio content with an identification of the user.

In another embodiment, a digital image capture device, comprises content capture control logic configured to capture a digital image representation of an element; a biometric sensor configured to detect a biometric parameter of a user of the digital image capture device; feature extraction control logic configured to extract one or more features of the captured biometric parameter; matching control logic configured to determine the identification of the user of the camera based on the extracted one or more features; and marking control logic configured to encode a digital representation of the captured image with an identification of the user.

In still another embodiment of the invention, a digital image capture device, comprises means for capturing content as a digital representation of the original content item; means for identifying an owner of the captured content; and means for encoding the digital representation of the content with the identification of the owner of the captured content. In one embodiment, the means for identifying, comprises at least one of a biometric sensor, a user input device and a data input.

In a further embodiment, a content capture device, comprises capture control logic configured to capture content as a digital representation of the original content item; identification control logic configured to identify an owner of the captured content; and marking control logic configured to encode the digital representation of the content with the identification of the owner of the captured content.

In accordance with one embodiment of the invention a digital camera, comprises optical elements configured to focus an image onto a focal plane; an image capture medium positioned at the focal plane configured to capture the image focused onto the focal plane; -image control logic configured to process an image captured by the image capture medium; identification control logic configured to identify an owner of the captured image; and marking control logic configured to encode a digital representation of the captured image with an identification of the owner. The identification control logic can comprise a biometric sensor configured to detect a biometric parameter of a user of the camera; feature extraction control logic configured to extract one or more features of the captured biometric parameter; and matching control logic configured to determine the identification of the owner of the content based on the extracted one or more features. The identification control logic can comprise control logic configured to accept an input to identify the, wherein the input comprises at least one of a keystroke entry, a data download, or a memory recall.

In accordance with another embodiment, a method of encoding a content item with an identification of an owner of the content, the method comprises capturing image content as a digital representation of the original- content element; identifying an owner of the captured content; and encoding the digital representation of the content with the identification of the owner of the captured content. In one implementation, identifying comprises sensing with a biometric sensor a biometric parameter of a user of the camera; extracting one or more features of the captured biometric parameter; and determining the identification of the user of the camera based on the extracted one or more features.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following figures The drawings are provided for purposes of illustration only and merely depict typical, or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a functional block diagram illustrating an example environment with which the invention can be implemented.

FIG. 2 is, a functional block diagram illustrating image capture and marking in accordance with one embodiment of the invention.

FIG. 3 is a functional block diagram illustrating owner identification and marking wherein a biometric sensor is used to identify the content owner in. accordance with one embodiment of the invention.

FIG. 4 is a functional block diagram illustrating an example embodiment wherein a biometric sensor is embedded-in a shutter button of a digital camera.

FIG. 5 is a functional block diagram illustrating the decoding of content information to determine an identification of the owner of the decoded content.

### DETAILED DESCRIPTION OF THE INVENTION

The present invention is directed toward a digital camera, digital video recorder or other content capture device having the functionality to encode identification information with the captured content to allow authentication and tracking of the encoded content item. More particularly, in accordance with one embodiment of the invention, an element is captured and a digital representation thereof is created. The element can be a scene captured by a digital still or video camera, sounds captured by an audio recorder or other element captured by a content capture device. The identification of the owner of the captured digital content is encoded into the content item, such that examination of the content item with appropriate decoding techniques reveals the identity of the author of that item. As a specific example, in one application a digital image is encoded with the identification of the photographer of a digital photograph such that the photographer can be identified in the original and in copies of the photograph. In this document, the term “owner” as used in the context of the owner of content is used to refer to an entity having rights to the captured content such as, for example, the author of the content, the legal owner of the content, the copyright holder of the content, a licensee of the content and so on.

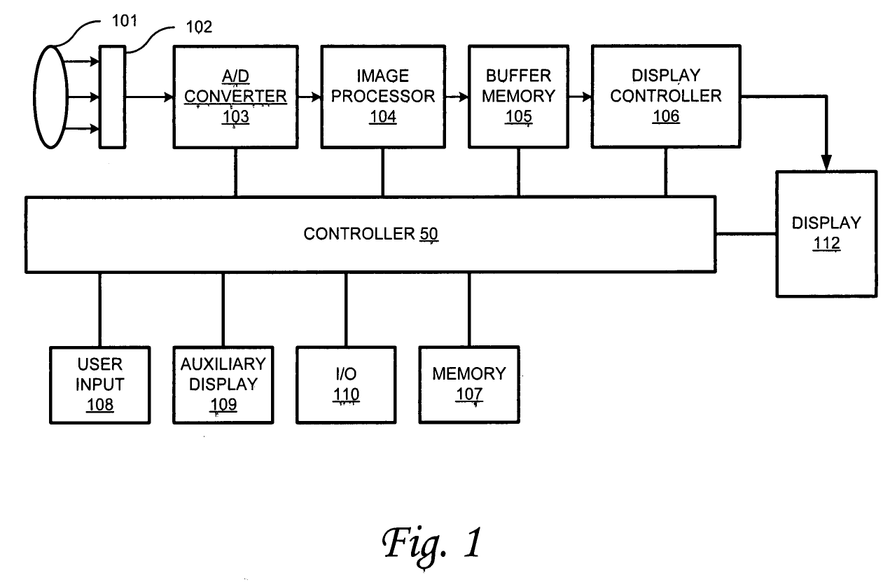

Before describing the invention in detail,, it is useful to describe an example environment with which the invention can be implemented. One such example environment is an image capture device such as, for example, a digital camera. Such image capture devices can be implemented in a number of different configurations using a number of different architectures.. As will become apparent to one of ordinary skill in the art after reading this description, implementation of the features and functionality of the present invention is not dependent on a particular or specific architecture of the device. However, to facilitate description of the features and functionality of the various embodiments of the invention, an example image capture device is described with, reference to FIG. 1.

Referring now to FIG. 1, the example image capture device illustrated is a digital camera. The exemplary device shown in FIG. 1 generally comprises, a controller 50, a lens 101 or series of lenses, an image capture device 102 such as a CCD (charge-coupled device) or other image sensor for converting an optical image applied through the lens 101 into an electrical signal, an A/D (analog/digital) converter 103 for converting the output signal of the image sensor 102 into digital data, and an image processor 104 for processing the output data of the A/D converter 103. Image processor 104 can perform other functions such as, for example, white balance adjustment, gamma correction, etc. Also included is a buffer memory 105 that can temporarily store image data for one or more images, each of which corresponds to one frame of image data processed in the image processor 104, for example.

Memory 107 can include one or more storage devices such as, for example, memory cards, RAM, ROM, disk devices, and other storage devices. Although not illustrated, a storage medium controller can also be provided. Images stored in memory 107 can be compressed using various forms of compression.

A display device 112 can include a display controller and a liquid crystal or other form of display panel for displaying images, menu screens and other information. The display controller can be implemented to fetch image data recorded during image pickup operation from the buffer memory 105, and causes the display panel to display them, so that a user can observe an image obtained during photographic operations. The display controller can also receive reproduced image data from the buffer memory 105 for display on the display panel, serving a function as an electronic viewfinder.

User input mechanisms. 108 are typically provided to allow the user to operate the digital camera and to control various settings and functions of the camera. User input mechanisms 108 can include, for example, buttons, switches, keypads, pointers, and other user input devices configured to accept input from a user. An auxiliary display 109 can also be provided to allow display of camera and other information to the user to facilitate operation and configuration of the camera. Also, an I/O device such as, for example, a serial data port, can be provided to allow the user to transfer images and other information into and out of the digital, camera. The system controller 50 is an element that generally controls the electronic camera and its components in order to realize various functions of the camera effectively.

Various processing modules, controller modules and other elements of the digital camera can be implemented using control logic. As used in this document, the term “control logic” can be used to refer to hardware, software, or a combination thereof, configured to perform the described functions. Control logic can include software, one or more processors, ASICs, PLAs, and other logic devices or components configured to implement the desired features and functions of image capture and processing as well as other features and functionality described herein.

Having thus described an example environment with which the invention can be implemented, the present invention is now described in greater detail. At times, this description of the present invention is made in terms of its application with the example environment illustrated in FIG. 1. However, as will become apparent to one of ordinary skill in the art after reading this description, the various features and functionality of the present invention can be implemented in alternative digital cameras environments, and indeed in other alternative environments. For example suitable environments. include digital video recorders, camera phones and other image capture devices, and digital audio recorders, just to name a few.

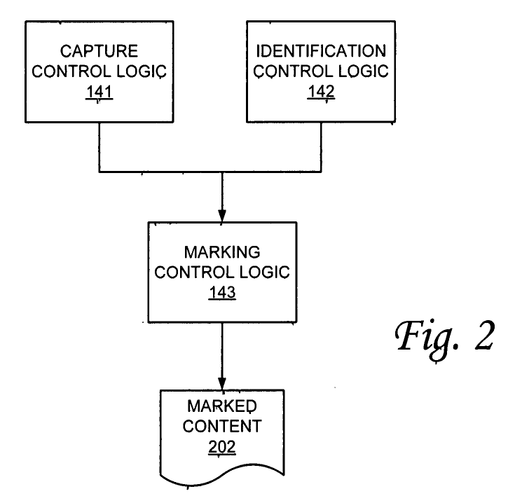

FIG. 2 is a functional block diagram of a content capture device in accordance with one embodiment of the invention. Referring now to FIG. 2, the content capture device includes capture control logic 141, identification control logic 142 and marking control logic 143. In operation, capture control logic 141 is used to capture the desired digital content. For example, in one application, capture control logic 141 comprises control logic used to capture a, digital still photograph such as that described above with reference to FIG. 1. Alternative image or content capture devices can be implemented as well. Identification control logic 142 is provided to capture the identity of or otherwise identify the owner of the captured content. Various embodiments of identification control logic are described in more detail below. Although illustrated separately, capture control logic 141 and identification control logic 142 can share one or more components of control logic to perform their respective functions, or their respective control logic can be implemented independently of one another. As one example, software running on a common processor may be implemented to invoke the respective functions of capture control logic 141 and identification control logic 142.

Marking control logic 143 provides the functionality of encoding the captured image with the identification provided by identification control logic 142. In one embodiment, marking control logic is implemented using the MarkAny image watermarking'software available through MarkAny, Inc., of Seoul, Korea, although other encoding mechanisms can be utilized. As with capture control logic 141 and identification control logic 142, marking control logic can be implemented independently of capture control logic 141 and identification control logic 142, or it can share one or more components thereof.

In this embodiment, marking control logic 143 embeds copyright, ownership or other identification information into the image in a manner that is imperceptible to the human eye. In this embodiment, the image is digitally watermarked by embedding imperceptible information into text, image, video and audio and other content that cannot be discerned by the human visual and auditory system. However, the watermark can be detected in the content item using electronic means. Again considering the example of a digital still photograph, in one embodiment a person viewing the photograph will not be able to see the watermark even though the watermark information is embedded in the original digital file. The encoding can be configured such that the watermark information will also be present in copies of the digital file as well as in files obtained by scanning the watermarked photograph.

As stated above, the identification control logic can be implemented, to obtain or otherwise provide the identification of the copyright holder or other interested party. For ease of description only, consider an example application wherein the content capture device is a digital still camera as described above with reference to FIG. 1. Further consider that the photographer wishes to identify the photographs that she takes as her own works In this example, identification control logic can provide the photographer's identification for marking, by marking control logic 143.. This can be accomplished in a number of different ways, including those methodologies and instrumentalities described herein.

For example, in one embodiment, the user's identity can be stored in memory or other storage device (for example, memory 107) in the digital camera. When a picture is taken, the marking control logic 143 encodes the image with the stored identification to provide marked content 202 (in this case, a watermarked photographs In one embodiment, the user can enter his or her identity using user input mechanisms 108 or by downloading it via I/O 110 or a removable memory device 107 or other input mechanism. For example, the user may key in a password or other unique keystroke sequence, swipe a badge or key fob, install a memory card or other memory device with his or her ID encoded thereon, and so on. Additionally, the invention can be implemented to allow the content capture device to store identifications of multiple users and allow the user to select his or her identification prior to taking a picture. As with the embodiment described above, this can be accomplished through user input. The identification of the user and access to the camera can be password protected to provide additional security measures.

In another embodiment, the identification used to encode an image may be that of someone other than the photographer. For example, in a situation where a photographer works for a magazine or other publication, the identity of the publishing company may be stored so that the publishing company can be identified as the owner of the captured images.

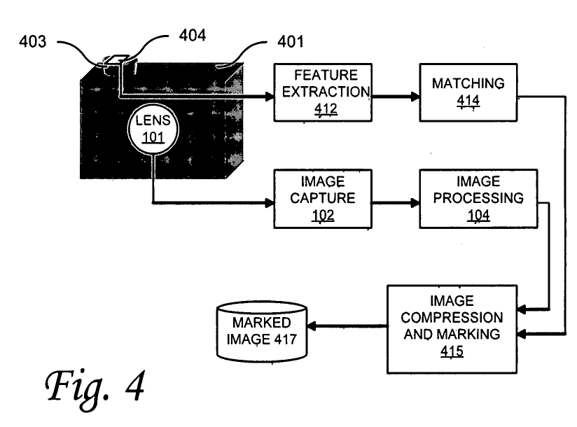

In another embodiment, a biometric information detector can be used to determine or facilitate determination of the identification of the user taking the picture. The biometric sensor can be used in one embodiment to sense a biometric parameter of the user. For example, in one embodiment a fingerprint sensor can be used to sense the user's fingerprint prior to or during the taking of pictures. The sensed fingerprint can be used to identify the photographer and to provide his or her identification to the marking control logic. In one embodiment, the fingerprint sensor can be embedded in or otherwise collocated with the shutter button, although other locations, are contemplated. In embodiments where the fingerprint sensor is placed at the location of finger contact on the shutter button, as the photographer depresses the shutter button to take a picture, his or her fingerprint is sensed for identification. This embodiment is described in further detail below with reference to FIG. 4 In another embodiment, a retinal scanner can be collocated with the viewfinder so as to provide a retinal scan of the user taking the photograph to thereby identify the photographer. As these examples serve to illustrate, other biometric sensors can be used to identify the owner of the content. In addition to identifying, the content owner, a biometric sensor can also be used to provide a security measure, allowing use of the camera by authorized users only as identified by their biometric information. This can also serve as a theft deterrent as, well as an access control measure.

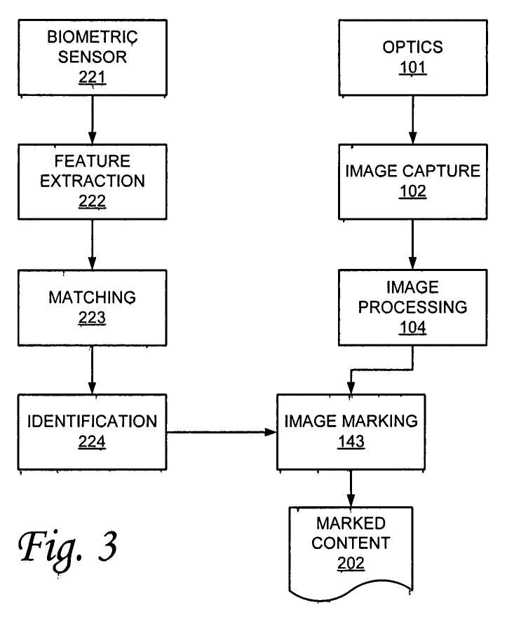

FIG. 3 is a functional block diagram illustrating identification, image capture and marking in accordance with one embodiment of the invention. Referring now to FIG. 3, in the illustrated embodiment, a biometric sensor 221 is provided to capture a biometric parameter or feature of the user. For example, as mentioned above, a fingerprint scanner or retinal scanner can be provided. For ease of description, the remainder of FIG. 3 is described in the example embodiment wherein biometric sensor 221 is a fingerprint scanner and the content capture device is a digital camera. Various forms of fingerprint scanner can be used including, for example, capacitive sensors, RF sensors, optical sensors, contact sensors, thermal sensors, swipe sensors, ultrasound sensors, and so on. After the fingerprint is scanned, the data is processed 222 and matched 223 to provide an identification 224 of the user.

To verify the identity of or to identify a user by extracting features from his or her fingerprint image, a fingerprint recognition algorithm or other control logic can be employed to performing processing 222 and matching 223 as outlined above. Thus, fingerprint processing control logic can be used to capture the characteristics of the corresponding, fingerprint. In one embodiment, this can be accomplished by processing the fingerprint image through multiple processing stages, such as, for example, image enhancement, image analysis, binarization, thinning, ridge reconstruction and feature extraction.

With the features, identified, fingerprint matching control logic can authenticate the identity of the person whose fingerprint is scanned by comparing feature data with templates or other information stored in a database or other accessible memory. This can be performed, for example using feature analysis. Feature analysis can be implemented to analyze the geometric characteristics such as distance and angle between standard features and its neighboring feature based on the analysis of the image-processed feature data. The geometric relationships of the features can be used as basic information for similarity measurement. Preferably, the system determines local and global similarities of the features with the stored data to determine the extent of the match. This data can be used to compute a similarity score between the scanned fingerprint and the extracted features.

In one embodiment, the fingerprint sensor is collocated with the shutter button, such that the user's fingerprint image can be captured upon depressing the shutter button. In these embodinments, image capture and processing can take place in parallel with identification.

FIG. 4 is an operational block diagram illustrating an example application of the invention wherein the fingerprint sensor is collocated with, and in this case embedded on the top of, a shutter button for a digital camera. Referring now to FIG. 4, the digital camera 401 can be implemented using any of a number of different digital camera embodiments, and in one example is implemented having the architecture as illustrated and described above with reference to FIG. 1. As such, in accordance with that example embodiment, digital camera 401 includes a lens 101 and other optical components including, for example, additional lens elements, a shutter, an image sensor, and other instrumentalities utilized to capture a representation of a scene that is to be photographed.

In this embodiment, digital camera 401 includes a shutter 403 used to control the taking of pictures by the photographer. Shutter 403 includes a fingerprint sensor 404 embedded therein such that when the user places his or her finger on the shutter button 403 to take a picture, fingerprint sensor 404 senses the user's fingerprint and provides the information for processing. As will become apparent to one of ordinary skill in the art after reading this discussion, processing of the fingerprint information can be accomplished using any of a number of fingerprint processing techniques including feature extraction and matching. Thus, the digital camera 401 illustrated in FIG. 4 includes feature extraction control logic 412 and matching control logic 414 to determine an identification of the user who depressed the shutter button for a current image. In one embodiment, feature extraction 412 and matching 414 can be implemented to perform the functions described above with reference to FIG. 3. Also illustrated in FIG. 4 are image capture 102 and image processing 104, used to process the digital image captured by the digital camera 401. As the referenced numerals indicate, this functionality can be implemented in a manner similar to that described with reference to the example environment illustrated in FIG. 1; however, alternative image capture and processing techniques can be employed.

Next, the image output from image processing 104 is encoded with the identification determined by matching 414 to create a marked image 417, which is illustrated as being stored in a memory device. In the illustrated embodiment, image compression and marking (illustrated by block 415) are performed such that the marking takes place in conjunction with image compression. Thus, for example, as a captured image is compressed or encoded into a JPEG or other format, it can also be encoded. The various processing elements described above, such as feature extraction 412, matching 414, image capture 102, image processing 104, and image compression and marking 415, can be implemented utilizing one or more elements of controllogic as described above with reference to the other embodiments.

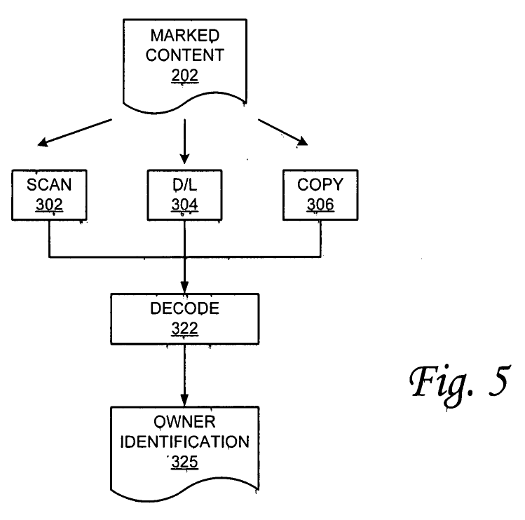

FIG. 5, is an operational block diagram illustrating a determination of owner identification from a marked content item 202. Referring now to FIG. 5, a marked content item 202 such as, for example, an encoded digital photograph or other content item is obtained for decoding. Thus, for example, a user wishing to determine the identification of an owner of an image may scan the image 302, download a copy of the image from a website or other database or storage location 304, or otherwise copy the file of the digital image to obtain a digital representation of that image or content 306. Thus, a decoder 322, which can be implemented utilizing control logic, is used to decode the content item 202 to determine whether it has been encoded with an owner identification and, if so, to produce that owner identification 325. As described above with reference to the encoding process, the decoding can be accomplished using the MarkAny image watermarking software available through MarkAny Inc., of Seoul, Korea, although other decoding mechanisms can be utilized. Thus, when a user comes across a content item (for example, a photograph) that that user believes he or she may have created, the user can download or otherwise obtain a copy of the image or even scan the image and run it through the decoding process to determine whether it was encoded with owner identification information.

While various embodiments of the present invention have been described above, it should be understood that they have been presented by way of example only, and not of limitation. Thus the breadth and scope of the present invention should not be limited by any of the above-described exemplary embodiments, but should be defined only in accordance with the following claims and their equivalents. Additionally, the invention is describedcabove in terms of various exemplary environments, embodiments and implementations. It should be understood that the various features and functionality described in one or more of the individual embodiments, environments or implementations are not limited in their applicability to the particular environment, embodiment or implementation with which they are described, but instead can be applied, alone or in some combination, to one or more alternative environments, embodiments or implementations of the invention, whether or not such environments, embodiments or implementations are described and whether or not such features are presented as being a part of a described environment, embodiment or implementation.

Terms and phrases used in this document, and variations thereof, unless otherwise expressly stated, should be construed as open ended as, opposed to limiting. As examples, of the foregoing: the term “including” should be read to mean “including, without limitation” or the like; the term “example” is used to provide exemplary instances of the item, in discussion, not an exhaustive or limiting list thereof; and adjectives like “conventional,” “traditional, normal,” “standard,” and terms of similar meaning should not be construed as limiting the item described to a given time period or to an item available as of a given time, but instead should be read to encompass conventional, traditional, normal, or standard technologies that may be available now or at any time in the future. A group of items linked with the conjunction “and” should not be read as requiring that each and every one of those items be present in the grouping, but rather should be read as “and/or” unless expressly stated otherwise. Likewise, a group of items linked with “or” should not be read as requiring mutual exclusivity among the items in the group, but rather should be read as “and/or” unless expressly stated otherwise.

What is claimed is:

1. A digital camera, comprising:
optical elements configured to focus an image onto a focal plane;
an image capture medium positioned at the focal plane configured to capture the image focused onto the focal plane;
image control logic configured to process-an image captured by the image capture medium;
a biometric sensor configured to detect a biometric parameter of a user of the camera;
feature extraction control logic configured to extract one or more features of the captured biometric parameter;
matching, control logic configured to determine the identification of the user of the camera based on the extracted one or more features; and
marking control logic configured to encode a digital representation of the captured image with an identification of the user.

2. The digital camera of claim 1, wherein said marking, control logic is further configured to compress the captured image.

3. The digital camera of claim 1, wherein said biometric sensor is at least one of a fingerprint sensor and a retinal scanner.

4. The digital camera of claim 1, wherein said biometric sensor is at least one of a fingerprint sensor collocated with a shutter button of the digital camera.

5. The digital camera of claim 1, wherein the digital camera is at least one of a digital still camera and a digital video camera.

6. The digital camera of claim 1, wherein the digital camera is further configured to capture audio content and said marking control logic is further configured to encode the captured audio content with an identification of the user.

7. The digital camera of claim 1, wherein the digital camera is embedded in a cellular telephone.

8. A digital image capture device, comprising:
content capture control logic configured to capture a digital image representation of an element;
a biometric sensor configured to detect a biometric parameter of a user of the digital image capture device;
feature extraction control logic configured to extract one or more features of the captured biometric parameter;
matching control logic configured to determine the identification of the user of the camera based on the extracted one or more features; and
marking control logic configured to encode a digital representation of the captured image with an identification of the user.

9. The digital image capture device of claim 8, wherein said marking control logic is further configured to compress the captured image.

10. The digital image capture device of claim 8, wherein said biometric sensor is at least one of a fingerprint sensor and a retinal scanner.

11. The digital image capture device of claim 8, wherein said biometric sensor is at least one of a fingerprint sensor collocated with a shutter button of the digital camera.

12. The digital image capture device of claim 8, wherein the digital image capture device is at least one of a digital still camera and a digital video camera.

13. A digital image capture device, comprising:
means for capturing content as a digital representation of the original content item;
means for identifying an owner of the captured content; and
means for encoding the digital representation of the content with the identification of the owner of the captured content.

14. The digital image capture device of claim 13, wherein said means for identifying, comprises at least one of a biometric sensor, a user input device and a data input.

15. A content capture device, comprising:
capture control logic configured to capture content as a digital representation of the original content item;
identification control logic configured to identify an owner of the captured content; and
marking control logic configured to encode the digital representation of the content with the identification of the owner of the captured content.

16. A digital camera comprising:
optical elements configured to focus an image onto a focal plane;
an image capture medium positioned at the focal plane configured to capture the image focused onto the focal plane;
image control logic configured to process an image captured by the image capture medium;
identification controllogic configured to identify an owner of the captured image; and
marking control logic configured to encode a digital representation of the captured image with an identification of the owner.

17. The digital camera of claim 16, wherein said identification control logic comprises a biometric sensor configured to detect a biometric parameter of a user of the camera; feature extraction control logic configured to extract one or more features of the captured biometric parameter; and matching control logic configured to determine the identification of the owner of the content based on the extracted one or more features.

18. The digital camera of claim 16, wherein said identification control logic comprises control logic configured to accept an input to identify the, wherein the input comprises at least one of a keystroke entry, a data download, or a memory recall.

19. In a digital camera, a method of encoding a content item with an identification of an owner of the content, the method comprising:
capturing image content as a digital representation of the original content element;
identifying an owner of the captured content; and
encoding the digital representation of the content with the identification of the owner of the captured content.

20. The method of claim 19, wherein said capturing comprises focusing an image onto a focal plane and capturing the focused image by an image capture device.

21. The method of claim 19, wherein said identifying comprises
sensing with a biometric sensor a biometric parameter of a user of the camera; e
extracting one or more features of the captured biometric parameter; and
determining the identification of the user of the camera based on the extracted one or more features.
